(19) United States
(12) Patent Application Publication
(10) Pub. No.: US 2015/0070873 A1
(43) Pub. Date: Mar. 12, 2015

(54) MACHINE TOOL WITH TOUCH CONTROL WORK LAMP AND USING METHOD THEREOF

(71) Applicant: Rexon Industrial Corp., Ltd., Taichung (TW)

(72) Inventors: Yung Chiang KU, Taichung (TW); Chung Chieh HUNG, Taichung (TW)

(73) Assignee: Rexon Industrial Corp., Ltd., Taichung (TW)

(21) Appl. No.: 14/474,879

(22) Filed: Sep. 2, 2014

(30) Foreign Application Priority Data
Sep. 6, 2013 (TW) 102132246

(51) Int. Cl. F21V 23/04; F21V 23/02; F21V 23/06; F21V 33/00

(52) U.S. Cl. CPC F21V 23/0485; F21V 33/00; F21V 23/02; F21V 23/06; F21W 2131/403
USPC 362/89

(57) ABSTRACT

A machine tool with a touch control work lamp includes a machine and a touch control work lamp. The touch control work lamp includes an electrically insulating lamp base disposed on the machine, a connecting member mounted onto the base and extending outwardly from the base, a casing engaged to the connecting member, and a light emitting unit disposed in the casing. By utilizing the touch control work lamp, the machine is prevented from breaking down or malfunctioning, and by using the electrically insulating lamp base, user safety is effectively enhanced.

### FIELD OF THE INVENTION

The present invention relates to a machine tool and a method of using the machine tool, and in particular to a machine tool with a touch control work lamp and a method of using the touch control work lamp of the machine tool.

### BACKGROUND OF THE INVENTION

In general, most factories are operated in a dusty environment, and mechanical switches of a lamp of a machine tool are usually covered by dust. If the position with accumulated dust is situated in gaps of the machine tool, and such position is a contact point of a switch, then the contact point of the switch will produce sparks or electric arcs when the machine tool is turned on or off After a long time of use, the dust will be carbonized to cause short circuits of the switch or abnormalities of the equipment. Since it is necessary to control and switch on the switch every time whenever illumination is needed, and the position of the lamp is adjusted. Such application is obviously inconvenient.

### SUMMARY OF THE INVENTION

Therefore, it is a primary objective of the present invention to provide a machine tool with a touch control work lamp capable of solving the aforementioned problem.

To achieve the aforementioned objective, the present invention provides a machine tool with a touch control work lamp, comprising: a machine and a touch control work lamp which is turned on or off by users through a touch control.

The touch control work lamp comprises an electrically insulating lamp base disposed on the machine, a connecting member mounted onto the base and extending outwardly from the base, and a light emitting unit installed at an end of the connecting member away from the base.

Another objective of the present invention is to provide a method of using a machine tool with a touch control work lamp, applied to a machine tool with a touch control work lamp. The machine tool comprises a machine, a worktable installed at the machine and provided for disposing a working object, and a touch control work lamp touched to turn on or off by a user. The touch control work lamp including an electrically insulating lamp base disposed on the machine, a connecting member mounted onto the base and extending outwardly from the base, and a light emitting unit installed at an end of the connecting member away from the base. The method comprises the steps of:

(A) Putting the workpiece on the worktable.

(B) Moving the touch control work lamp such that the position of the light emitting unit corresponds to the workpiece, while touching to turn on the touch control work lamp, so that the light emitting unit emits light.

(C) Touching to turn off the touch control work lamp, so that the light emitting unit does not emit light.

The present invention has the following advantages and effects: The design of the touch control work lamp can prevent the machine tool from being stuck by dust, the circuit from being shorted, or the equipment from breaking down, so as to improve the convenience of use. In addition, the electrically insulating lamp base can improve the safety of use.

### BRIEF DESCRIPTION OF THE DRAWINGS

Other characteristics and effects of the present invention will become apparent in the following detailed description with reference to the accompanied drawings, in which:

FIG. 1 is a schematic view of a machine tool with a touch control work lamp in accordance with a preferred embodiment of the present invention;

FIG. 2 is a schematic view of a touch control work lamp in accordance with a preferred embodiment of the present invention; and

FIG. 3 is a schematic circuit diagram of a control circuit and a light emitting unit in accordance with a preferred embodiment of the present invention.

It should be noted that the drawing figures are not necessarily drawn to scale, but instead are drawn to provide a better understanding of the components thereof, and are not intended to be limiting in scope, but rather to provide exemplary illustrations. It should further be noted that the figures illustrate exemplary embodiments of the present invention and the components thereof, and in no way limits the structures, configurations and components thereof according to the present disclosure.

### DETAILED DESCRIPTION

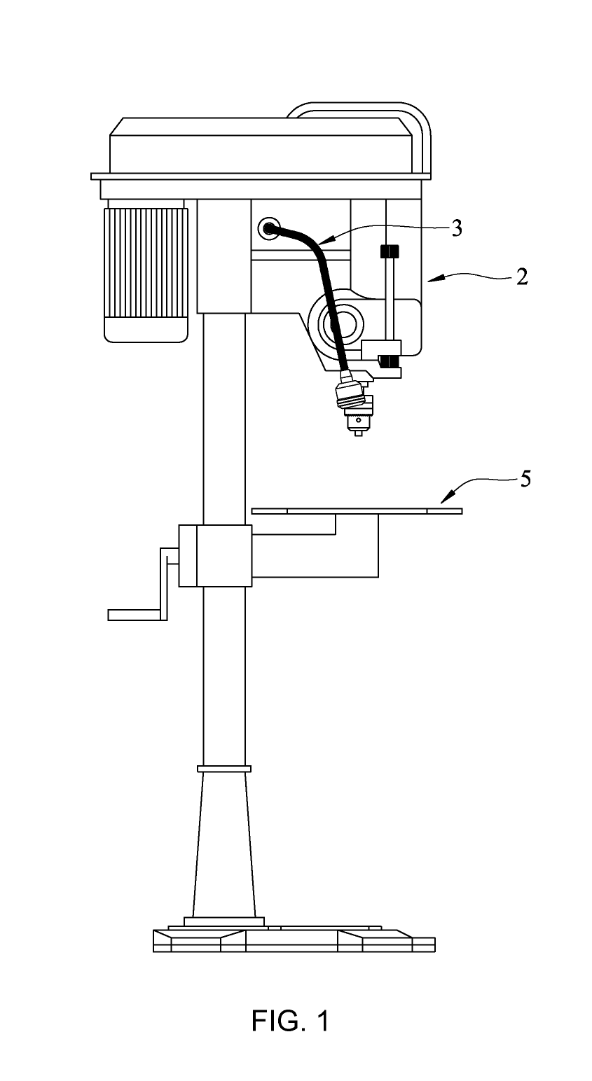

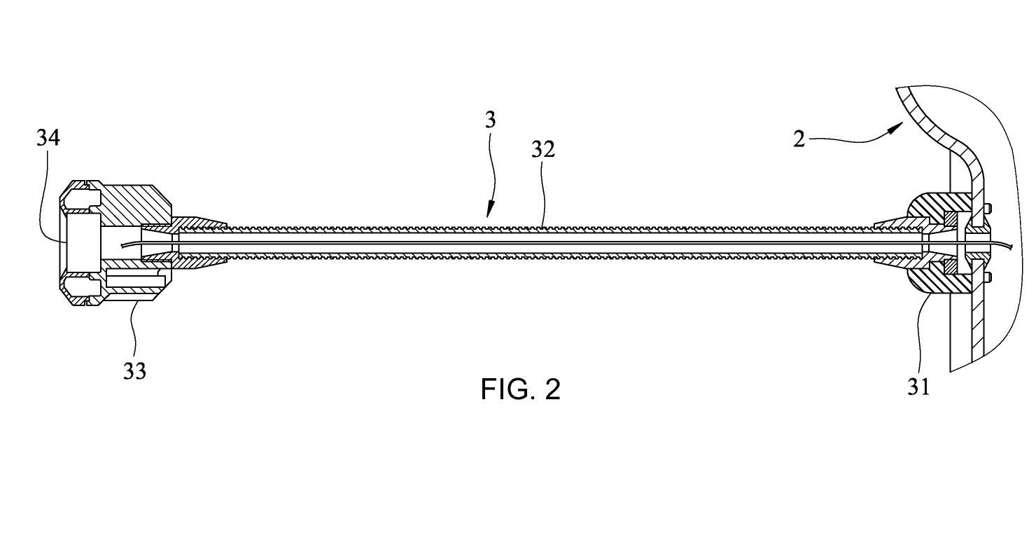

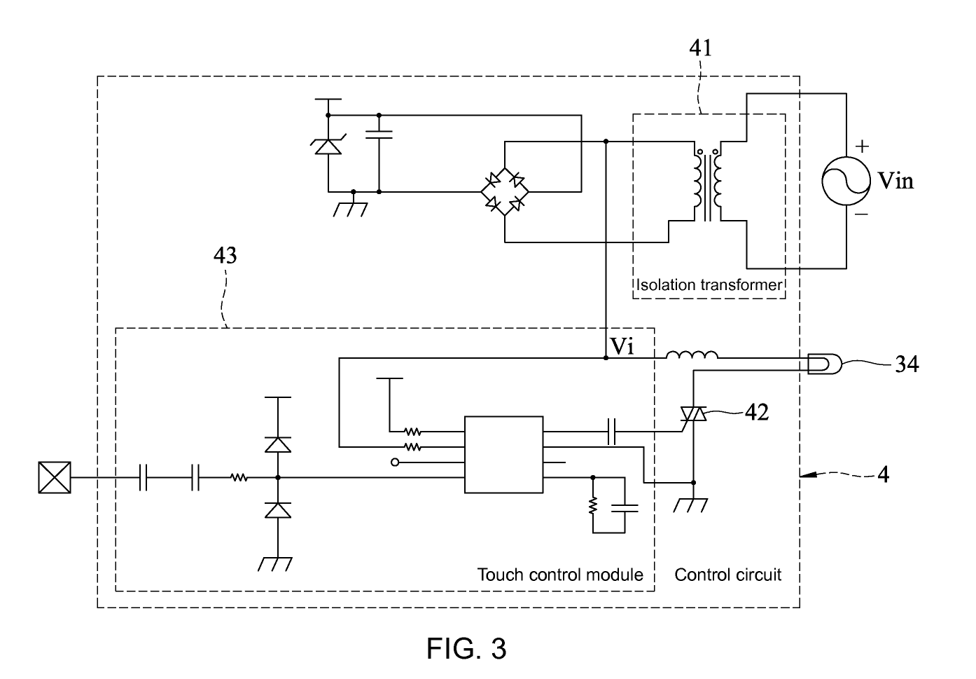

With reference to FIGS. 1, 2 and 3 for a machine tool with a touch control work lamp in accordance with a preferred embodiment of the present invention, the machine tool comprises: a machine 2 (only a portion is shown in FIG. 2), a touch control work lamp 3, a control circuit 4, and a worktable 5 installed at the machine 2 for disposing a workpiece (not shown in the figure).

The touch control work lamp 3 includes an electrically insulating lamp base 31 installed at the machine 2, a connecting member 32 made of a flexible material is mounted onto the base 31 and extending outwardly from the base 31, a casing 33 installed at an end of the connecting member 32 away from the base 31, and a light emitting unit 34 installed at the casing 33.

In this embodiment, the base 31 is made of a material including but not limited to a plastic material or any other electrically insulating material.

In this embodiment, the touch control work lamp 3 is in the form of a gooseneck lamp, and the connecting member 32 may be flexibly bent and used by a user to adjust the illuminating position of the light emitting unit 34. However, the invention is not limited to only such an arrangement.

The control circuit 4 includes: an isolation transformer 41 that receives an input power Vin to output an internal power Vi, an electronic switch 42 connected in series with the light emitting unit 34 and installed between the internal power Vi and a grounding terminal, controlled by a control signal to selectively switch to a conducted status and a non-conducted status, and a touch control module 43 that receives a touch signal to output the control signal.

In this embodiment, the electronic switch 42 is a triode alternating current (TRIAC) semiconductor switch or any other non-mechanical switch that is not affected by dust, and the input power Vin may be the mains power, but the invention is not limited to such arrangement only.

In a general application, users simply touch the connecting member 32 or the casing 33 to generate the touch signal. After the touch control module 43 receives the touch signal to output the control signal, the electronic switch 42 is controlled to switch to a conducted status or a non-conducted status. When the electronic switch 42 is conducted, the light emitting unit 34 is situated at a light emitting status. When the electronic switch 42 is not conducted, the light emitting unit 34 is situated at a non light emitting status.

Therefore, the electronic switch 42 may be used to control the light emitting unit 34 to emit light or not to emit light through the touch control operation.

In this embodiment, the users may touch the connecting member 32 or the casing 33 to generate the touch signal. Of course, the user may just touch the connecting member 32 or just touch the casing 33 to generate the touch signal.

In summation, this embodiment of the present invention has the following advantages:

1. The touch control work lamp 3 may be used together with the electronic switch 42 (or the TRIAC semiconductor switch) in this preferred embodiment to replace the mechanical switch, so as to prevent the machine tool from being stuck by accumulated dust, the short circuit at the contact points, or the abnormality of the equipment. In addition, the electronic switch 42 has a longer service life, and the influence (such as blinking) caused by instantaneous currents produced when turning on the touch control work lamp 3 can be minimized to improve the comfort and safety of use.

2. When a current leakage of the machine 2 occurs in the situation without installing any grounding circuit, users may be electrically shocked by touching the touch control work lamp 3, and thus having an underlying apprehension to public safety. In this preferred embodiment, the design of the electrically insulating base 31 can insulate the touch control work lamp 3 and the machine 2 to prevent the accident of electric shocks, so as to improve the safety of use.

3. When a user holds the connecting member 32 or the casing 33 to adjust the illuminating position of the light emitting unit 34, the user may touch the connecting member 32 or the casing 33 to generate the touch signal, so that the illuminating position may be adjusted while controlling the light emitting unit 34 to emit light or not to emit light. For example, the illuminating position of the light emitting unit 34 is adjusted, while the light emitting unit 34 is also simultaneously being controlled to emit light, or when the light emitting unit 34 is adjusted to return to its original position, the light emitting unit 34 is also simultaneously being controlled not to emit light. Unlike the prior art that requires a mechanical switch for turning on or off the light emitting unit before adjusting the illuminating position, the present invention provides a more convenient and time-saving application.

4. Since the touch control work lamp 3 is very sensitive to the change of electric charges, electric noise interferences may easily cause malfunctions of the touch control work lamp 3. The AC noises that cause malfunctions of the touch control work lamp 3 used in a factory are mainly transient surges, and their source generally comes from lightning strikes, the failure of electric transmission circuits, the malfunction of grounding large power equipments, the startup or shutdown of motor-driven large equipments, the arcing or not arcing instantaneous current of a welding operation, the instantaneous current for turning on or off large breakers, etc. The design of the isolation transformer 41 provides the effect of isolating transient surges.

Most transient surges affect circuits through a grounding terminal (or grounding line) and can be isolated and insulated completely by a primary side and a secondary side of the isolation transformer 41, so that the transient surges transmitted from the grounding terminal can be isolated. This is the problem that general transformers (such as auto transformers) with common grounding cannot overcome. In addition, an iron core (which is not shown in the figure and is generally a silicon steel plate) of the isolation transformer 41 consumes high-frequency signals, so that the isolation transformer 41 also has the effect of inhibiting high-frequency noises to prevent the circuits from being interfered by high-frequency AC noises.

The method of using the aforementioned machine tool with a touch control work lamp comprises the following steps:

(A) Putting the workpiece on the worktable 5.

(B) Moving the touch control work lamp 3, such that the position of the light emitting unit 34 corresponds to the workpiece, while touching to turn on the touch control work lamp 3, so that the light emitting unit 34 emits light.

(C) Touching to turn off the touch control work lamp 3, so that the light emitting unit 34 does not emit light.

In the Step (C), the touch control work lamp 3 is moved to return to its original position, while touching to turn off the touch control work lamp 3, so that the light emitting unit 34 does not emit light.

In summation of the description above, the present invention not only prevents the abnormality of the equipment caused by dust and improves the safety of use, but also isolates transient surges and reduces malfunctions caused by electric noise interferences. Thus, the present invention can achieve the aforementioned objectives.

While the invention has been described by means of specific embodiments, numerous modifications and variations could be made thereto by those skilled in the art without departing from the scope and spirit of the invention set forth in the claims.

What is claimed is:

1. A machine tool with a touch control work lamp, comprising:
a machine; and
a touch control work lamp, turned on or off by a user with a touch, the touch control work lamp including an electrically insulating lamp base disposed on the machine, a connecting member mounted onto the base and extending outwardly from the base, and a light emitting unit installed at an end of the connecting member away from the base.

2. The machine tool with a touch control work lamp according to claim 1, further comprising a control circuit, the control circuit including an electronic switch connected in series with the light emitting unit and installed between an internal power supply and a grounding terminal, and controlled by a control signal to selectively switch to a conducting status and a non-conducting status, and a touch control module that receives a touch signal to output the control signal.

3. The machine tool with a touch control work lamp according to claim 2, wherein the electronic switch is a triode alternating current (TRIAC) semiconductor switch.

4. The machine tool with a touch control work lamp according to claim 2, wherein the control circuit further comprises an isolation transformer that receives an input power to output an internal power.

5. The machine tool with a touch control work lamp according to claim 2, wherein the touch control work lamp further comprises a casing installed at an end of the connecting member away from the base and partially covering the light emitting unit, and wherein the casing generates the touch signal after being touched.

6. The machine tool with a touch control work lamp according to claim 2, wherein the connecting member is touched to generate the touch signal.

7. The machine tool with a touch control work lamp according to claim 1, wherein the connecting member is made of a flexible material.

8. The machine tool with a touch control work lamp according to claim 1, wherein the touch control work lamp is in form of a gooseneck lamp.

9. A method of using a machine tool with a touch control work lamp, applied in a machine tool with a touch control work lamp, and the machine tool comprising a machine, a worktable installed at the machine and provided for disposing a workpiece, and a touch control work lamp touched to turn on or off by a user, and the touch control work lamp including an electrically insulating lamp base disposed on the machine, a connecting member mounted onto the base and extending outwardly from the base, and a light emitting unit installed at an end of the connecting member away from the base, the method of using comprising the steps of:
(A) putting the workpiece on the worktable;
(B) moving the touch control work lamp such that the position of the light emitting unit corresponds to the workpiece, while touching to turn on the touch control work lamp, so that the light emitting unit emits light; and
(C) touching to turn off the touch control work lamp, so that the light emitting unit does not emit light.

10. The method of using a machine tool with a touch control work lamp according to claim 9, wherein the step (C) is to touch and turn off the touch control work lamp when returning the touch control work lamp to its original position, so that the light emitting unit does not emit light.
